(19) United States
(12) Patent Application Publication
(10) Pub. No.: US 2026/0162236 A1
(43) Pub. Date: Jun. 11, 2026

(54) SYSTEMS AND METHODS FOR MACHINE LEARNING IMAGE PROCESSING AND ANALYSIS

(71) Applicant: Acushnet Company, Fairhaven, MA (US)

(72) Inventors: Paul A. FURZE, Tiverton, RI (US); Idris SCREEN, Lincoln, RI (US); Jeremy Zorrilla DE LOS SANTOS, Whitinsville, MA (US); Leonidas AMARANT, Middletown, RI (US); Charles HIGHTOWER, Hyde Park, MA (US); Douglas S. GOGUEN, Lakeville, MA (US); Richard DAPRATO, Acushnet, MA (US); William D. HATHAWAY, Williamsburg, MA (US)

(73) Assignee: Acushnet Company, Fairhaven, MA (US)

(21) Appl. No.: 18/972,658

(22) Filed: Dec. 6, 2024

(51) Int. Cl. G06T 7/00

(52) U.S. Cl. CPC G06T 7/0002; G06T 2207/20081; G06T 2207/30224

(57) ABSTRACT

In some implementations, a system may include an imaging device, at least one memory storing instructions, and at least one processor configured to execute the instructions to perform operations for assessing product damage. The operations may comprise receiving an image of a product to be graded, the image being captured via the imaging device. The operations may further comprise generating a set of assessment images based on the received image. The operations may also comprise analyzing the set of assessment images using a machine learning model, the machine learning model being trained based on a plurality of product images to recognize product damage and generate a grade based on the recognized product damage. Further, the operations may comprise outputting a grade for the product based on the analyzing by the machine learning model.

### TECHNICAL FIELD

The present disclosure relates generally to devices, systems, and methods for machine learning image processing and analysis for identifying anomalies and/or damage, and more particularly the present disclosure relates to image processing analysis to analyze images of products utilizing machine learning to categorize and classify anomalies and/or damage.

### BACKGROUND

Machine Learning is a subset of artificial intelligence that allows computers to learn and improve without explicit programming. machine learning uses algorithms to analyze data and identify patterns, which are then used to create a model that can make predictions or categorizations. Certain methods leverage machine learning for image process. machine learning image processing is a combination of image processing and machine learning that can be used to identify objects in images and recognize patterns. Some applications of machine learning image processing include: pattern recognition, image identification, or character recognition.

Image processing and recognition can aid in assessing quality of products and for production control. For example, image processing can be used to identify anomalies or damages in images of products. Current image processing, however, has limitations for certain applications. Some image processing techniques are unable to distinguish certain anomalies from another, determinations can be subjective and based on the reviewing method or algorithm, and certain methods of image processing do not have the level of granularity required for accurate classification or assessment and ultimately require human intervention for an accurate assessment.

The devices, systems, and methods of the present disclosure solve one or more of the problems set forth above and/or other problems of the prior art with a new image processing technique that leverages machine learning methods for a more accurate image processing evaluation of products. For example, the disclosed implementation of machine learning aspects to, e.g., generate scores which are objective and consistent, thereby improving the processor(s) or computing device(s) described herein (e.g., making the processor(s) faster by not requiring human individuals to assess products (or image thereof) and provide such scores; or enabling the processor(s) to provide more accurate data based on the generated scores, which are both more objective and more consistent as compared to the current state of the art).

### SUMMARY

Some aspects of the present disclosure are directed to systems for assessing damage in a product. According to some embodiments, the system may include an imaging device, at least one memory storing instructions, and at least one processor configured to execute the instructions to perform operations for assessing product damage. In some embodiments, the operations may include receiving an image of a product to be graded, the image being captured via the imaging device. In some embodiments, the operations may further include generating a set of assessment images based on the received image. In some embodiments, the operations may also include analyzing the set of assessment images using a machine learning model, the machine learning model being trained based on a plurality of product images to recognize product damage and generate a grade based on the recognized product damage. Further, according to some embodiments, the operations may include outputting a grade for the product based on the analyzing by the machine learning model. In some embodiments, the disclosed systems are specifically configured to assess damage in products.

Other aspects of the present invention are directed to computer-implemented methods for assessing product damage using image recognition. According to some disclosed embodiments, the methods may include a step of receiving an image of a product to be graded, the image being captured via an imaging device. In some embodiments, the method may further include generating a set of assessment images based on the received image. In some embodiments, the method may also include analyzing the set of assessment images using a machine learning model, the machine learning model being trained based on a plurality of product images to recognize product damage and generate a grade based on the recognized product damage. Further, in some embodiments, the method may include outputting a grade for the products based on the analyzing by the machine learning model. In some embodiments, the disclosed methods may be tailored to specifically assess damage or anomalies in products.

Yet other aspects of the present disclosure are directed to networked devices (e.g., computer servers) configured to execute operations for product damage assessments. In some embodiments, the networked device may include one or more processors to perform the operations for assessing product damage. In some embodiments, the operations may include the steps of obtaining a plurality of first images of first products having varying degrees of damage, inputting the plurality of first images to a machine learning model as training data, training the machine learning model to recognize and grade a severity of damage to a second product based on a received second image of the second product, receiving the second image of the second product to be graded, analyzing the second image using the trained machine learning model, and outputting a grade for the second product based on the analysis of the second image by the machine learning model. In some embodiments, the networked device may be configurable to assess damage in products.

### BRIEF DESCRIPTION OF THE DRAWINGS

The foregoing and other aspects of the present disclosure are best understood from the following detailed description when read in connection with the accompanying drawings. It is to be understood that the disclosure is not limited to the illustrated or disclosed embodiments. Included in the drawings are the following Figures:

FIG. 1 is a block diagram of an exemplary system for assessing product damage, consistent with disclosed embodiments.

FIG. 2 is a block diagram of an exemplary operating environment, consistent with disclosed embodiments.

FIGS. 3A and 3B are illustrations of an exemplary received product images, consistent with disclosed embodiments.

FIGS. 4A-4D are illustrations of exemplary assessment images, consistent with disclosed embodiments.

FIGS. 5A and 5B are illustrations of example graphical user interfaces (GUIs), consistent with disclosed embodiments.

FIG. 6 is a graph showing an example assessment of a product for damage, consistent with disclosed embodiments.

FIG. 7 is a graph showing another example assessment of a product for damage, consistent with disclosed embodiments.

FIG. 8 is a graph showing another example assessment of a product for damage, consistent with disclosed embodiments.

FIG. 9 is a graph showing another example assessment of a product for damage, consistent with disclosed embodiments.

FIG. 10 is a flow chart of an exemplary method for assessing product damage, consistent with disclosed embodiments.

FIG. 11 is a flow chart of an exemplary method for training a machine learning model, consistent with disclosed embodiments.

FIG. 12 is a flow chart of another exemplary method for assessing product damage, consistent with disclosed embodiments.

FIG. 13 is a flow chart of another exemplary method for assessing product damage, consistent with disclosed embodiments.

FIG. 14 is a flow chart of another exemplary method for training a machine learning model, consistent with disclosed embodiments.

### DETAILED DESCRIPTION

Exemplary embodiments are described with reference to the accompanying drawings. In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence nor constrained to a particular system configuration. Additionally, some of the described embodiments or elements thereof can occur or be performed (e.g., executed) simultaneously, at the same point in time, or concurrently.

Technical problems exist in the current state of the art of assessing product damage (e.g., shear testing) using either human and/or computer vision assessment for grading products based on assessed damage. These technical problems include lack of efficiency, accuracy, and consistency in the grading process. For example, current human and/or computer vision grading techniques cannot recognize the same damage on different products (e.g., golf balls or golf clubs), or at least cannot consistently do so. If, for example, a human individual were to grade a set of product (e.g., golf ball or golf clubs) images, each image showing similar types of damage, the score generated by the human individual would oscillate even if the damage were exactly the same. The same issue exists for current computer vision techniques that have low accuracy, employ complex image recognition techniques, or require too many computational resources. The methods, systems, and media disclosed herein address such technical problems by incorporating machine learning into the grading process.

For example, disclosed embodiments describe training the machine learning model(s) to output consistent and accurate scores and improving human or computer vision aspects with machine learning model(s) results in an improved process and system for grading products based on product images. Even further, disclosed system, methods, and media also improve the process and system by generating assessment images which may further clarify the product damage for the machine learning model(s) to analyze prior to generating a score. Thus, the disclosure provides for an improved process and particular method of assessing product damage based on received images, and generating scores based on the damage.

The methods, systems, and media disclosed herein further provide technical improvements to the fields of artificial intelligence and damage processing technology. For example, embodiments of the present disclosure increase the efficiency and accuracy of systems and methods (and processor(s)) for grading products based on surface damage, as well as generating surface height plots, from input containing images of the surface of products. For instance, a machine learning model consistent with disclosed embodiments may output a grade in response to a user input comprising one or more images of a product. As a result, the user may not be required to have any knowledge or experience with respect to assessing product damage in order to receive information from the machine learning model (as currently required in extant processes). Furthermore, the machine learning model outputs information that is far more objective and consistent than similar information that might be provided by a human grader of the same product or image thereof. As discussed above, the same product image may receive a different grade if a human (or even computer vision) grader is utilized. Additionally, a set of rules (e.g., training data) that is input to a machine learning model will be treated much more objectively than the same set of rules provided to a human grader. By avoiding such issues, the present disclosure provides an improved process for assessing product damage based on received images.

In some embodiments, the machine learning model may also be trained using large datasets of code and/or natural language, which may be sourced from disparate places, enabling the model to learn to generate, and to generate, accurate damage scores and indicators of product damage, even if the received image quality is poor or there are inconsistencies between assessed products. This is particularly helpful for the process of assessing product damage based on received product images because certain damage may be difficult to identify or otherwise assess (e.g., if the damage is hard to see, such as internal damage or deep damage, or if many different types of damage are possible). While human graders receiving such large datasets would not be beneficial, the machine learning model is capable of handling such large datasets and the output generated (e.g., scores) is improved to be, e.g., more accurate, consistent, and objective, by training the model using such large datasets, which encompass details relating to the types of damage and thereby enable the machine learning model to, e.g., identify minor details or distinguish between different types of damage. The present disclosure further improves machine learning model performance itself by providing methods and systems for fine-tuning trained machine learning models based on known information related to a product surface (e.g., dimple patterns, markings, etc.), known associations between the surface information and graphical data, and other data that is newly sourced or generated by the models themselves.

Practical application examples of the present disclosure may include assessment of product damage (e.g., shear testing or production anomalies) on a large scale and at a rate previously not possible. Other practical application examples include generating objective and consistent grades based on received product images. Overall, the present disclosure may be used to assist in the process of shear testing, allowing for more accurate and consistent results while simultaneously minimizing the resources required for performing the shear testing.

Some disclosed embodiments automate many programming tasks, many of which are prone to human error and/or are incredibly time intensive, allowing human individuals to focus on higher-level tasks and increasing overall productivity. For example, engineers may focus their efforts on, e.g., performing further steps based on the accurate output (e.g., scores, ratings, damage plots, or other machine-generated data) generated by the machine learning model, or further fine-tuning the machine learning model.

Reference will now be made in detail to the disclosed embodiments, examples of which are illustrated in the accompanying drawings. Illustrative embodiments of the present disclosure are described below.

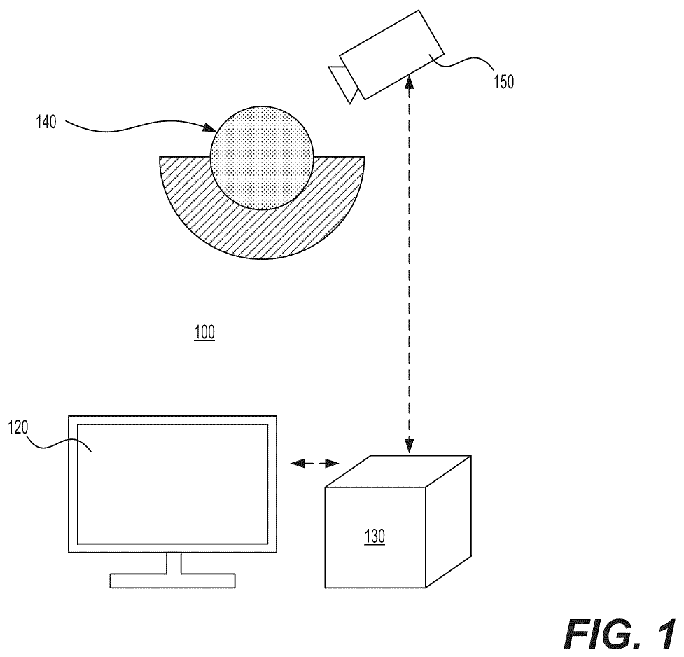

FIG. 1 illustrates an exemplary embodiment of a system 100 for assessing product damage, according to disclosed embodiments. In some embodiments, the product may be a golf ball. In some exemplary embodiments, system 100 includes an imaging device 150, at least one memory storing instructions (not shown in FIG. 1), and at least one processor 130 configured to execute the instructions to perform operations for assessing product damage. It will be understood that imaging device 150 may include a wide area three-dimensional measurement system, and/or a two-dimensional or three-dimensional profiler system. Exemplary imaging devices may include a three-dimensional optical scanner or imager, that is configured to obtain an image of a product's surface (e.g., product 140) and accurately capture height variations along the product's surface. Imaging device 150 may have one or more cameras having a resolution of at least 0.001 inches per pixel and 0.001 inches per unit change in brightness. Imaging device 150 may also include, e.g., high-speed cameras, optical microscopes, infrared imaging devices, x-ray imaging devices, magnetic resonance imaging (MRI) devices, phased array imaging devices, electron-based imaging devices, or other high-speed imaging, infrared thermography, or non-invasive imaging devices. Imaging device 150 may also have imaging sources in multiple frequencies and the ability to form composite images. For example, in some embodiments imaging device 150 may include multi-wavelength image capturing and processing capabilities to generate composite images. Imaging device 150 may be a three-dimensional imaging device or can contain other types of cameras configured to obtain one or more digital images of the product. Imaging device 150 may be configured to generate high resolution images, datasets, height plots, files, and/or other elements associated with scanning the product 140. As further depicted in FIG. 1, system 100 may also include a display 120 (e.g., a screen, a computer display, or other interface) for providing output generated by the processor(s) 130 to a user.

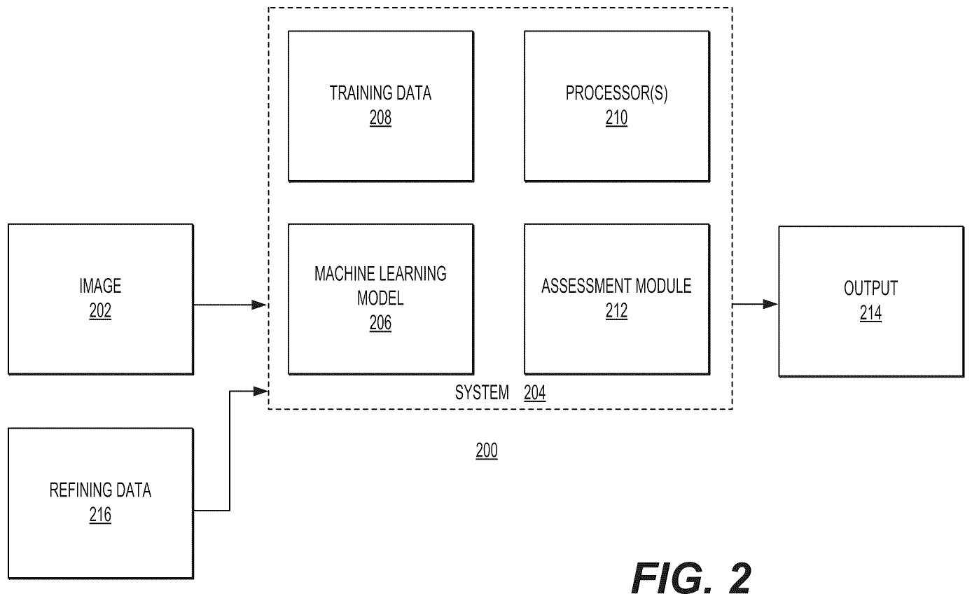

FIG. 2 illustrates an exemplary operating environment 200 for assessing product damage, according to disclosed embodiments. As shown in FIG. 2, exemplary operating environment 200 includes system 204 which receives an image 202 and ultimately generates an output 214 based on the received image 202. The received image 202 may be a visual representation (e.g., a picture, a photograph, or another type of illustration). In other embodiments, the received image 202 may be provided in another format for representing information as captured by an imaging device (e.g., imaging device 150). For example, in some embodiments, received image 202 may include a set of values (e.g., image values and coordinates provided in a spreadsheet, chart, table, or other document). A point cloud, in which a set of values within a spreadsheet may be mapped to a 3D coordinate system, is an example of such a set of values.

In some exemplary embodiments, one or more memory devices may be associated with the system. Such memory devices may store, for example, data and/or one or more control routines, instructions, mathematical models, algorithms, machine learning models, etc. The one or more memory devices may embody non-transitory computer-readable media, for example, Random Access Memory (RAM) devices, NOR or NAND flash memory devices, and Read Only Memory (ROM) devices, CD-ROMs, hard disks, floppy drives, optical media, solid state storage media, etc.

In some embodiments, a power supply may be configured to supply power for operation of one or more components of the system. For example, a power supply may be configured to supply power for operation of an imaging device and connected components such as, e.g., a processor and a display screen. A power supply may be electrically connected to the components via one or more connectors or wires (not shown in Figures). In some embodiments, a power supply may include a battery. In other embodiments, a power supply may be connectable to an external power grid for receiving power from the external power grid. Multiple power supplies may be connected to the system to accommodate the needs of the various devices.

In some embodiments, one or more communication lines may transfer signals from the imaging device to a processor (and vice versa) and/or from the processor to a display screen. Communication lines may include, e.g., serial communication lines, universal serial bus (USB) communication lines, Ethernet communication lines, or inter-integrated circuit (I2C) communication lines. It is contemplated, however, that in some exemplary embodiments, the imaging device may be configured to transfer or receive signals wirelessly to or from the processor (or wirelessly from the processor to the display screen or another component of the system or operating environment).

With further reference to FIG. 2, system 204 may further include machine learning model 206, training data 208, processor(s) 210, and assessment module 212. System 204 may also receive refining data 216 for further training (e.g., for fine-tuning machine learning model 206). Image 202 may, e.g., be an image captured by an imaging device (e.g., imaging device 150). Output 214 may include a score, grade, rating, attribute, graphical data, text or voice data, or other generated data associated with a received image and based on product damage that is identified from the received image. Product damage, as used herein, may refer to any type of wear, tear, or deformation that affects the appearance and which may ultimately affect the performance or integrity of a product (specific types of product damage are described elsewhere herein). As an example, system 204 may output a score based on specific damage identified on a particular received image of a product. In some embodiments, the score may be indicative of the durability of the given product.

As further shown in FIG. 2, assessment module 212 of system 204 may pre-process received image 202 prior to (or at least separate from) analysis of an image by machine learning model 206. For example, assessment module 212 may generate one or more assessment images based on received image 202. An assessment image may be generated by assessment module 212 by any of the techniques described below (or any combination thereof). Based on the generation process, an assessment image may contain more detailed information and clarity of the product damage, wherein such damage may or may not be identifiable solely from received image 202. The assessment image generated by assessment module 212 may then be provided to machine learning model 206 for grading, and machine learning model 206 may thus be enabled to provide an accurate and objective score based on the assessment image rather than based on the received image 202, which may or may not be as clear or indicative of the actual product damage.

Various image processing and enhancement techniques may be applied by the system (e.g., via assessment module 212, or via machine learning model 206). These techniques may, e.g., highlight particular defects, enhance the contrast of the surface of the product, or provide a more detailed view of the damaged areas. The following is a non-exhaustive list of methods and technologies which may be used by the system (e.g., via assessment module 212, or via machine learning model 206) to enhance the visibility of the product damage in the received image.

Increasing the resolution of the received image may reveal finer details of the damage, such as hairline cracks and micro-abrasions, which are not originally visible in the received image. Similarly, zooming in on a particular region of the product surface may reveal similar finer details of the damage. Zooming in may be performed without losing image or resolution quality.

Adjusting the contrast of the received image may enhance visibility. For example, subtle damage may become more apparent by adjusting the contrast (either up or down) to accentuate differences between damaged and undamaged areas. As another example, increased contrast may reveal other surface damage which is not visible (or at least less visible) in the received image.

The received image may also be corrected or adjusted for brightness and exposure. Such correcting may include balancing light such that the image becomes evenly lit. Another technique for correcting may include preventing shadows from existing in the image. Correcting or adjusting for brightness and exposure may result in an image having greater detail and lacking obstructive elements.

Edge detection may also be applied (e.g., via one or more edge detection algorithms). Edge detection may provide outlines of cracks, seams, or other product damage, thereby making such features easily distinguishable and identifiable by the machine learning model. Edge detection may further enhance details of the damage by enhancing the definition of all edges in the image, which would include the product damage.

The received image may also be enhanced for color. For example, adjusting the color levels or using false color techniques may differentiate damaged areas from non-damaged areas, particularly for paint or coloring-related damage. As another example, color may be enhanced to highlight variations of color in the received image. This, in turn, may indicate damage more clearly, particular damage such as fading or discoloration.

The received image may also be exposed to filtering. Filtering, as used herein, may refer to manipulating an image by applying a filter to alter its appearance or extract specific information (e.g., product damage). Filters may refer to mathematical operations or algorithms that may modify the intensity values of an image's pixels based on certain input criteria. For example, unwanted noise or distortions that may obscure damage may be removed from the received image using a filter having a threshold associated with a certain noise level desired to be omitted. As another example, sharpening filters (e.g., filters which increase the intensity values of pixels) may be applied to the received image to make details more distinct, thereby revealing both highly evident and subtle damage.

Magnification or zoom techniques may also be applied to the received image. For example, digital magnification may be used to zoom into specific areas of interest, further enhancing the visibility of even minor damage. As another example, combining multiple views of different angles of the damage may enable the machine learning model to have a more comprehensive perspective on the damage. For example, the machine learning model may be enabled to create a 3D model of the product to visualize damage to that product from a variety of different angles. Furthermore, based on the generated 3D model, the machine learning model may measure volume loss or deformation within the 3D model itself to assess the damage.

The assessment image may further reveal the number or arrangement of dimples (e.g., a dimple pattern) on the product's surface, and such information may be utilized during grading or analyzing. Similarly, the depth and shape of each dimple may become more visible, thereby further clarifying surface deviations of the product.

Surface imperfections, however minor, may be clarified as well in the assessment images. For example, any cracks, chips, or other imperfections may become more clearly visible in the image. As another example, anomalies in the material or construction, such as seams or uneven areas, may become more clearly visible in the image.

In combination with additional imaging technologies, subsurface features or layers of the product may also be captured to assess internal integrity.

As a result of the further clarity provided via the assessment images, various specific types of damage may become identifiable more readily (e.g., by a machine learning model trained to grade images of products having varying degrees of damage). For example, the following types of damage may be identified from the assessment image(s).

Surface cracks, such as hairline cracks or deep cracks. Hairline cracks may refer to fine cracks on the surface that may be indicative of material fatigue. Deep cracks may refer to more severe cracks that may penetrate deeper into the ball.

Scuffs and abrasions, such as superficial scuffs and deep abrasions. Superficial scuffs may refer to light surface scuffs caused by contact with hard surfaces. Deep abrasions may refer to more significant abrasions that could alter the surface texture of the product.

Cuts and tears, such as surface cuts and material tears. Surface cuts may refer to visible cuts that can occur from sharp objects. Material tears may refer to tears in the outer cover, potentially exposing the underlying layers of the product.

Chips and nicks, such as edge chips and surface nicks. Edge chips may refer to small chips along the edges of the dimples. Surface nicks may refer to nicks in the ball's surface, e.g., from repeated impact or collision with hard surfaces.

Deformation, such as shape deformation and compression dents. Shape deformation may refer to any deformation in the ball's roundness due to impact damage or pressure changes. Compression dents may refer to dents from repeated compressive forces (e.g., forces from a swung golf club).

Paint damage, such as chipped paint and faded paint. Chipped paint may refer to areas where the paint has chipped away, exposing the material underneath. Faded paint may refer to fading of the paint due to UV exposure or chemical reactions.

Dimple damage, such as dimple deformation and obstructed dimples. Dimple deformation may refer to changes in dimple shape or depth. Obstructed dimples may refer to foreign materials or debris lodged in the dimples.

Seam damage, such as seam splitting and seam misalignment. Seam splitting may refer to visible splitting or separation along a seam of the product. Seam misalignment may refer to misalignment of the seam due to force applied to the product.

Core exposure, such as visible core and core cracks. Visible core may refer to exposure of the core material through the outer layers, often due to impact. Core cracks may refer to cracks in the core, detectable, e.g., through advanced imaging techniques.

Impact marks, such as club face impressions and impact craters. Club face impressions may refer to indentations or marks left by an impacting club face. Impact craters may refer to small craters from high-velocity impacts with hard surfaces.

Foreign substances, such as residue deposits or adhesive material. Residue deposits may refer to the presence of substances such as mud, grass, or chemicals that can obscure surface features of the product. Adhesive material may refer to any external material (e.g., liquids, fluids) that might stick to the product.

Aging signs, such as brittleness or material degradation. Brittleness may refer to signs of aging such as frailty (e.g., a thinning outer surface), making the ball more susceptible to damage. Material degradation may refer to the breakdown of material over time, as visible through surface texture changes.

Accordingly, by improving the received image and providing the improved image (e.g., assessment image) to a machine learning model, the machine learning model is enabled to generate an improved grade (e.g., output 214) based on the improved image and the clarified damage to the product. It will be understood that such output may be generated continuously for various images of products having various degrees of damage.

With further reference to FIG. 2, exemplary system 204 may further include training data 208, and machine learning model 206 may be trained using training data 208. Training data, as used herein, may refer to the initial dataset used to train a machine learning model. Such an initial dataset may include, e.g., input-output pairs, where the inputs are the features from which the model learns, and the outputs are the correct or expected responses (e.g., labels or targets). The model may use this initial dataset to identify patterns, learn correlations, and build its understanding of the problem it is being trained to solve (e.g., providing a grade based on an image). Machine learning model 206 may also further be trained based on refining data 216. The model may, e.g., adjust its parameters (e.g., weights) to minimize error in its predictions based on refining data 216. Refining data, as used herein, may refer to additional datasets or information used for fine-tuning a machine learning model. Fine-tuning may refer to a process of adjusting a model already trained on a larger, more general dataset (e.g., an initial dataset) to better suit the specific task or domain of grading products based on damage. In this case, the refining data may include smaller, domain-specific datasets (e.g., datasets that account for dimple patterns or logos/icons expected to be found on particular products), which allow the model to adapt and further improve its performance in grading or otherwise assessing products (or images thereof) based on damage.

In some embodiments, system 204 may be configured to perform operations. In some embodiments, the operations may include receiving an image of a product to be graded (e.g., image 202), the image being captured via an imaging device (e.g., imaging device 150 of FIG. 1).

In some embodiments, the imaging device (e.g., imaging device 150) may include an adjustable aperture lens or a color sensor (or a calibrated measurement tool (e.g., a color calibrator or photogrammetric calibrator)). An adjustable aperture lens, as used herein, may refer to a type of camera lens that allows for changing the size of the aperture opening, either manually (e.g., via a physical ring on the lens or camera controls) or automatically (e.g., via automatic adjustment based on exposure settings or program modes). The aperture opening refers to the opening in a lens through which light passes to enter the camera of an imaging device. Adjusting the aperture opening size may control the amount of light that reaches the camera (or a sensor thereof) and influences other aspects of a captured image, such as the depth of field and the sharpness. Hence, an adjustable aperture lens may improve the imaging device by enabling control over light exposure, depth of field, image sharpness, and motion blur. Such flexibility may improve the quality, versatility, and functionality of the imaging device. A color sensor, as used herein, may refer to a device that detects and measures color by capturing the wavelengths of light reflected from objects. A color sensor may include photodetectors, color filters, analog to digital converters, light sources, and/or microcontrollers. A color sensor may improve the imaging device by, e.g., enhancing its ability to accurately capture, reproduce, and process colors and producing more precise and true-to-life color representation in images that are captured by the imaging device. The imaging device may also include an onboard graphics processing unit (GPU, e.g., a graphics processor that is built directly into the motherboard or CPU of a device rather than being a separate, dedicated graphics card) or an AI chip (e.g., a specialized hardware component engineered to perform complex computations for AI workloads, such as deep learning, neural networks, and inference processing, which often require large amounts of parallel computing power).

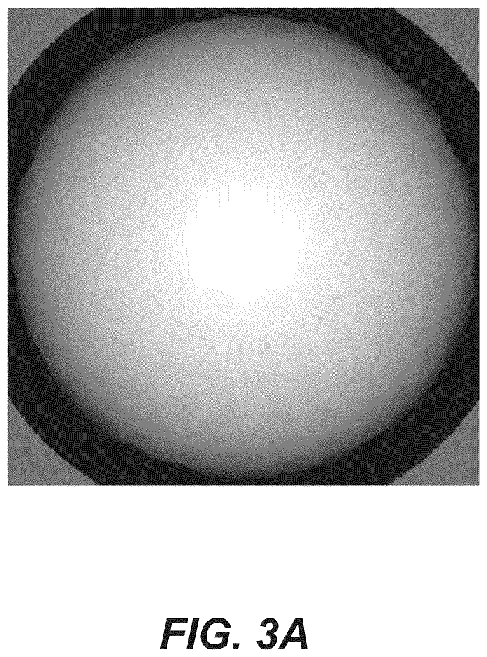

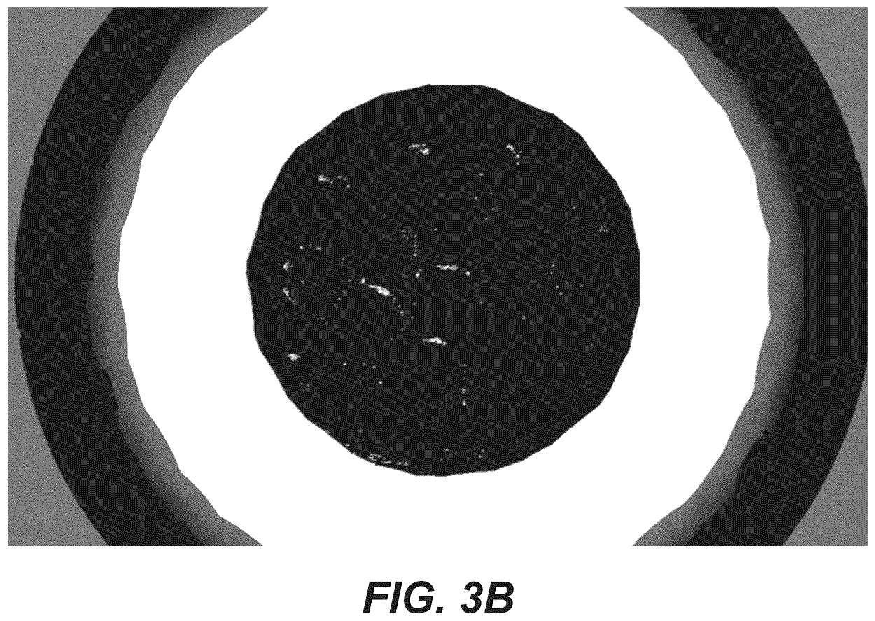

FIG. 3A illustrates an exemplary image captured by an imaging device (e.g., by imaging device 150), according to disclosed embodiments. The imaging device may be configured to obtain or capture an image, such as the example shown in FIG. 3A. FIG. 3A shows one example of a three-dimensional monochrome height image of the product. It will be understood that fully colored height images of the product can also be generated by the imaging device. The images of the product can also be three-dimensional and the imaging device can use associated software or electronic equipment to allow a user to view the product model or images at various angles, prior to generating of the image that is eventually input to the system. As an example, the outer surface of the golf ball may be scanned via the imaging device to acquire at least one first initial image of the golf ball. The imaging device may comprise, e.g., a wide area three-dimensional measurement system, and/or a two-dimensional or three-dimensional profiler system. Exemplary equipment for performing the capturing of the image may include a three-dimensional optical scanner or imager (or imaging device), that is configured to obtain an image of a golf ball's surface and accurately capture height variations along the golf ball's surface. The imager may have a resolution of at least 0.001 inches per pixel and 0.001 inches per unit change in brightness, for example. The imager may be a three-dimensional imager. The imager may be configured to generate high resolution images, datasets, height plots, files, and/or other elements associated with scanning the golf ball. Furthermore, a holder may be configured to position the golf ball relative to the imager. One of ordinary skill in the art would understand that the holder may be stationary or configured to hold the golf ball in one position, or the holder may be dynamic or adjustable such that the golf ball may be rotated or otherwise moved while being supported within the holder. An X-Y adjustment stage can be provided to rotate the golf ball. An X-Y-Z adjustment assembly can alternatively be provided to move the golf ball. One of ordinary skill in the art would understand that various positioning configurations may be provided in which the imager is mobile or stationary, and/or the holder is mobile or stationary. Positioning devices may have multiple degrees of freedom such that images may be captured of the golf ball from any angle, distance, orientation, etc. The capturing of the image via an imaging device is further described in U.S. patent application Ser. No. 18/321,012, filed May 22, 2023, the disclosure of which is incorporated herein by reference in its entirety.

FIG. 3B illustrates an exemplary assessment image generated using a particular filter, or threshold, according to disclosed embodiments. This particular image illustrated in FIG. 3B shows a specific damage condition as set based on a predefined threshold, where damage to the product surface is indicated by spots or specks of white on the otherwise black image of the product. As shown in FIG. 3B, a low threshold may be applied to the received image of the product. Using this exemplary threshold setting, a significant portion of the product surface has indications of marring or damage (as visually shown via the white spots or specks that are in the otherwise black area of the product). The damage shown in FIG. 3B may correspond, e.g., to minor scrapes, scratches, or indentations, based on the low threshold. It will be understood that greater threshold settings may similarly be applied to filter for more significant abrasions or cuts.

In some embodiments, and as a further example, the high-pass filter function may be configured to attenuate signals associated with a first subset of surface height deviations due to dimples and curvature in the received image of the product (e.g., golf ball) and pass through signals associated with a second subset of surface height deviations due to product damage (e.g., golf ball damage). Thus, a predetermined threshold may be set in order to indicate deviations resulting from product damage, and to hide deviations resulting from dimples or curvature of the product. Based on the set threshold, an assessment image may show deviations resulting solely from product damage, while the received image may show deviations resulting from both product damage and dimples or curvature.

In some embodiments, the operations (performed, e.g., by system 204) may further include generating a set of assessment images based on the received image (e.g., image 202). The generating may be performed, e.g., by assessment module 212. Assessment images, as used herein, may refer to enhanced or otherwise processed (e.g., reformatted) images that are created from the received image. A set of assessment images may refer to one or more assessment images. Example assessment images may include images with increased resolution, images of enlarged portions of the product, annotated images or annotated portions of a product, and other processed or reformatted images that more clearly delineate or indicate product damage.

In some embodiments, the plurality of assessment images may include images in different spectrums including at least two colors. Spectrums, as used herein, may refer to ranges of wavelengths of light (e.g., colors). Viewing the received image in a particular spectrum may be beneficial to, e.g., highlight a particular type of damage or a particular attribute of the damage that may be more visible or identifiable when the image is shown in a specific spectrum or color.

In some embodiments, generating the set of assessment images may include at least one of applying a high-pass filter function to the received image via a computing system (as described in further detail in U.S. patent application Ser. No. 18/321,012), modifying contrast, color, hue, or sharpness of the received image, or reformatting the received image. Reformatting, as used herein, may refer to any one of rotating, shifting, scaling, flipping, cropping, zooming, altering shape, color jittering (e.g., applying random variations to the colors of an image), normalizing pixels, standardizing pixels, performing color conversion, masking out (e.g., selectively excluding or modifying specific parts of an image), or otherwise augmenting or processing an image or a portion thereof.

Applying a high-pass filter, such as a high-pass filter process, technique or function, may provide at least one first filtered image and/or at least one first filtered dataset and/or at least one first plot. One of ordinary skill in the art would understand that the term “image” may refer to a file or data element, and can also include an associated data or text file. The filter can be a software or hardware enabled or implemented tool, in one example. The terms “high-pass filter” and “high-pass filter function” are used interchangeably herein. The filtering technique may include obtaining a smoothed signal associated with the data captured by the scans or images, and comparing the smoothed signal to an original or raw signal associated with the data captured by the scans or images. In one aspect, an initial plot of the height profile of the golf ball surface may be compared to another plot of the height profile of a damaged golf ball surface. A comparison of the plots may yield detailed information regarding marring or shear damage to the golf ball surface that has been induced by the damaging treatment, while the filtering technique can be applied to the plots to reduce or mute changes in the plot of the height profile that are due to dimples or other inherent golf ball surface geometry features.

The high-pass filter may be configured to attenuate signals associated with a first subset of surface height deviations due to, e.g., dimples and curvature of golf ball, and pass through signals associated with a second subset of surface height deviations due to damage. The filter may be adjusted to target or identify areas above or below predefined thresholds.

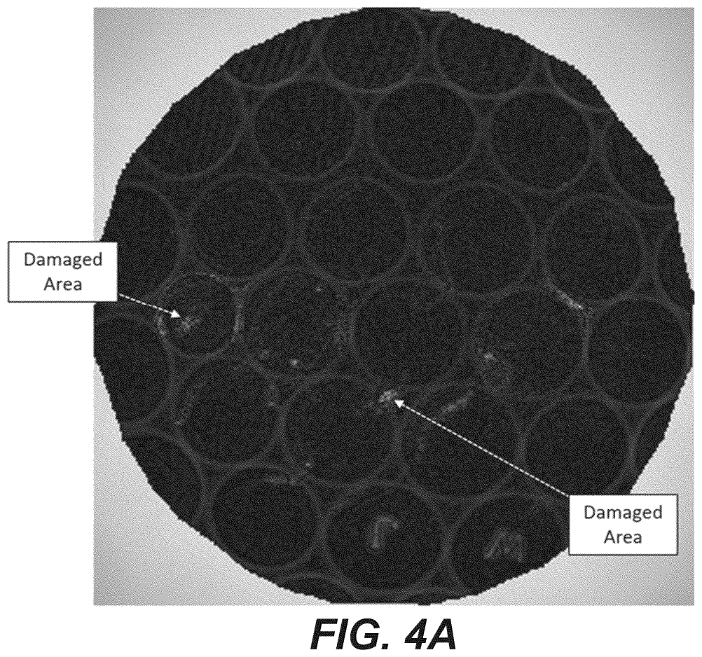

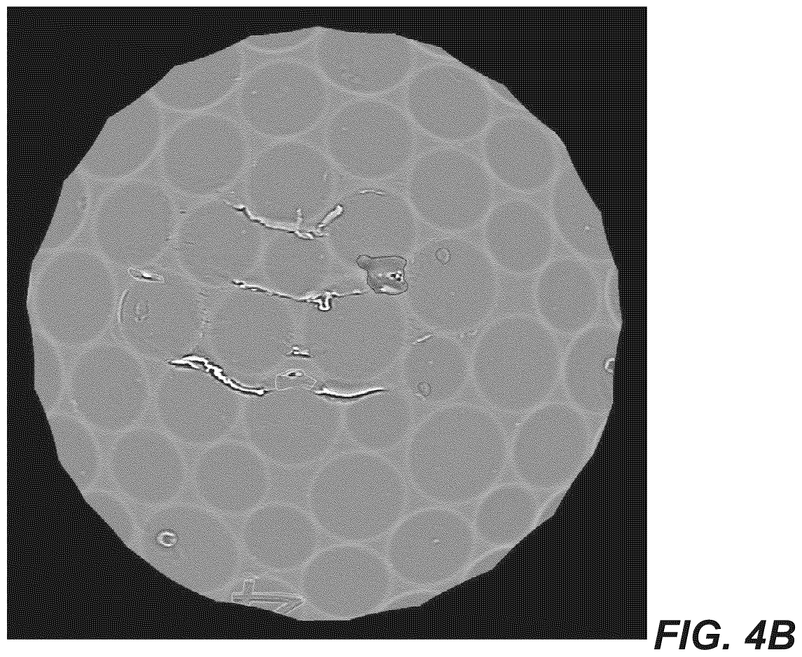

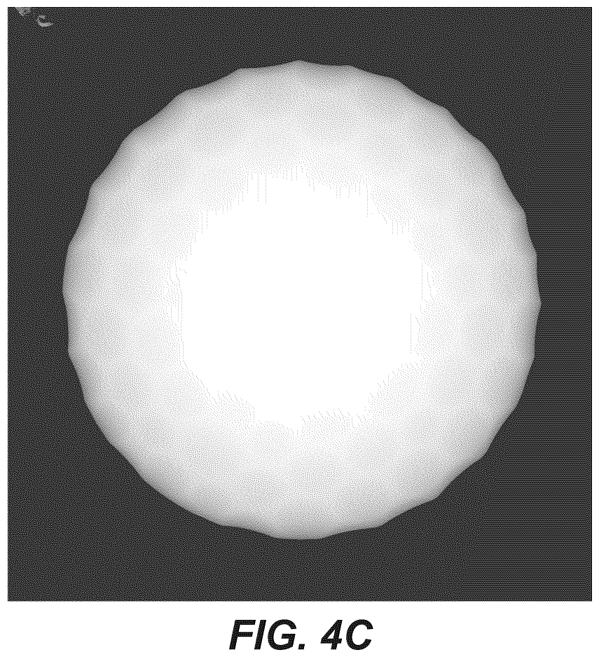

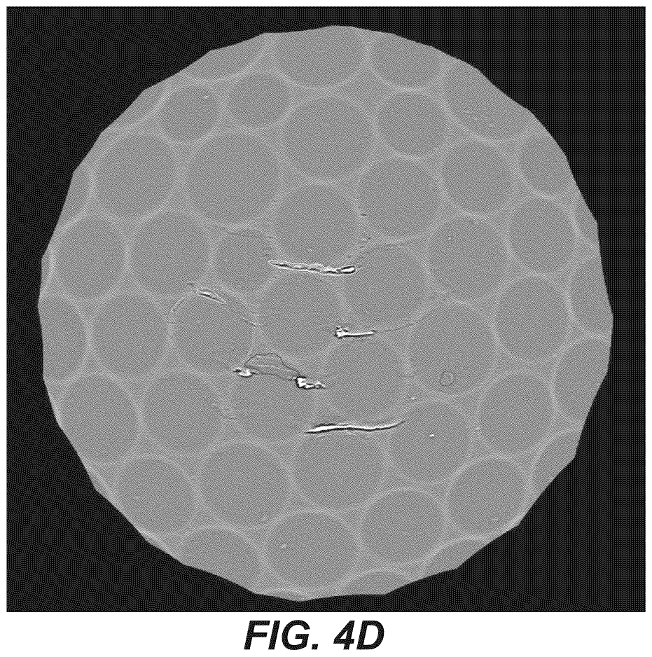

FIGS. 4A-4D illustrate further exemplary assessment images, any of which may form at least part of a set of assessment images, according to disclosed embodiments. Each of these figures is described in more detail below.

FIG. 4A illustrates an exemplary assessment image of a product with a high-pass filter function applied to the image, such that surface features associated with ordinary product surface geometry, i.e., dimples, curvature, may be muted or filtered out while particular surface features (e.g., those indicative of damage) may remain. It will be understood that additional image processing functions could be applied further to this image or any other images of the product. As shown in FIG. 4A, damaged areas are identifiable via the gray areas or the white areas on the otherwise black image of the product surface. Lighter, non-black areas correspond to areas of the surface that differ more from the smoothed image. Dimple outlines are also visible in this image, but they are less prominent than (and thus distinguishable from) the damaged areas identifiable via the high-pass filter function.

FIG. 4B illustrates an exemplary assessment image of a product that has been reformatted by altering the image contrast (more specifically, by altering a baseline of the image contrast, such that differences/deviations in absolute values may be more easily identifiable while peak values may be minimized). In this example image, the surface features indicative of damage are further highlighted based on the reformatting (e.g., darker and centered), while other surface features (e.g., dimple pattern, curvature) are clearly delineated, e.g., as shown via a different color (grey) and shading (light) as compared to the surface features indicative of damage. FIG. 4B thereby illustrates an example of reformatting of a received image that leads to improved analysis of product damage (e.g., based on a reformatted image that includes more relevant detail based on a change in image contrast or a baseline thereof).

FIG. 4C illustrates an exemplary assessment image of a product that has been reformatted to have increased brightness. In this example image, the surface features indicative of damage are less highlighted based on the reformatting. It will be understood that different types of reformatting may be beneficial in highlighting certain damage while other types of reformatting may not be as beneficial, as exemplified by FIG. 4C. An assessment module (e.g., assessment module 212), or another component of a system (e.g., system 204), may perform various reformatting techniques (as described herein) to a received image in order to assess the image and provide a best assessment image from a plurality of assessment images (or various best assessment images). A best assessment image, as used herein, may refer to a reformatted received image of a product that is more indicative of product damage than at least one other reformatted received image. Disclosed systems may therefore generate various assessment images and then determine a best assessment image from the various generated images.

FIG. 4D illustrates an exemplary assessment image of a product that has been reformatted and rotated. In this example image, the surface features indicative of damage are both further highlighted and further centered. It will be understood that the same image (or various images) may be rotated in various manners to create several assessment images having varying perspectives of the product damage. Such assessment images may be helpful, e.g., in assessing product damage from a variety of angles.

In some embodiments, the operations (performed, e.g., by system 204) may further include analyzing the set of assessment images using a machine learning model (e.g., machine learning model 206), the machine learning model being trained based on a plurality of product images to recognize product damage and generate a grade based on the recognized product damage. Analyzing, as used herein, may refer to inspecting a received image to identify deviations along the surface of a product.

In some embodiments, analyzing the set of assessment images may include a first stage of identifying a damage area. A damage area, as used herein, may refer to any portion of a product (or surface thereof) that includes product damage or a surface deviation (as described herein). In some embodiments, analyzing the set of assessment images may further include modifying the image to focus on the damage area. Modifying the image to focus on the damage area may refer to rotating, zooming in or out, or otherwise augmenting the image to show more clearly the damage area and focus less on other areas which do not include product damage. In some embodiments, analyzing the set of assessment images may also include a second stage of identifying a damage type in the damage area. A damage type, as used herein, may refer to a category or grouping of product damage (e.g., scuff, abrasion, cut, coloring, etc.). In some embodiments, analyzing the set of assessment images may further include a third stage of determining a level of the identified damage type. A level of damage type, as used herein, may refer to data relating to the severity of the identified damage type (e.g., low, medium, high, or an integer value).

In some embodiments, the operations (performed, e.g., by system 204) may further include training the machine learning model. In some embodiments, training may include obtaining a plurality of training images of products (e.g., golf balls) having varying degrees of damage, inputting the plurality of training images to a machine learning model (e.g., machine learning model 206) as training data, and training the machine learning model, based on the plurality of training images, to recognize product damage (e.g., golf ball damage) in a received image of a product and grade the product (e.g., golf ball) based on the recognized product damage.

Training the machine learning model may refer to adding, removing, or modifying a model parameter. Training of a machine learning model may be supervised, semi-supervised, or unsupervised. In some embodiments, training of a machine learning model may include multiple epochs, or passes of data (e.g., training data 208) through a machine learning model process (e.g., a training process). In some embodiments, different epochs may have different degrees of supervision (e.g., supervised, semi-supervised, or unsupervised). Training data may also include data previously output from a model (e.g., forming recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, trillions, or even billions of model parameters. A machine learning model may be or may include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or another type of artificial intelligence model.

In some embodiments, a machine learning model (e.g., machine learning model 206) may further be trained to determine the grade based on an identified type of damage or an extent thereof, and the operations may further include outputting the identified type of damage or the extent thereof. In some embodiments, the type of damage may include an abrasion, a dent, a crack, a cut, or coloring. An abrasion, as used herein, may refer to physical damage or wear (e.g., a scuff) that occurs on the surface of a product due to, e.g., repeated impact and contact with various surfaces. A dent, as used herein, may refer to a deformation or indentation on the surface of a product. Unlike cuts or abrasions, a dent is typically a shallow depression that alters the original shape of the product surface. A crack, as used herein, may refer to fracture or break in the surface of the product that can penetrate through the outer cover and sometimes even into the core. A cut, as used herein, may refer to a physical defect on the surface of the product that penetrates deeper than an abrasion or scuff. Coloring, as used herein, may refer to discoloration or staining of the product's surface, as well as paint damage. Paint damage may refer to damage to the colored coating of the product, which may occur as a result of, e.g., chipping, fading, peeling, scratching, or discoloration.

In some embodiments, the operations may further include inputting refining data (e.g., refining data 216) to a machine learning model (e.g., machine learning model 206), and further training the machine learning model using the refining data, wherein the refining data indicates an association between received training data (e.g., training data 208) and at least one of a type of product material (e.g., golf ball surface material) or a type of dimple pattern (e.g., a golf ball dimple pattern). For example, the refining data may include information associated with a particular product's dimple pattern, which would assist in contrasting between surface deviations resulting from the dimple pattern as opposed to surface deviations resulting from damage to the product.

In some embodiments, the operations may further include annotating the received image or at least one of the set of assessment images to indicate damage to a corresponding product and inputting the annotated image to the machine learning model as additional training data. For example, one or more image annotation tools may be utilized to draw bounding boxes, polygons, segmentation masks, or other informative symbols to highlight damage areas of the product, and these annotations may be exported as training data to be fed to a machine learning model using one or more frameworks or object detection models.

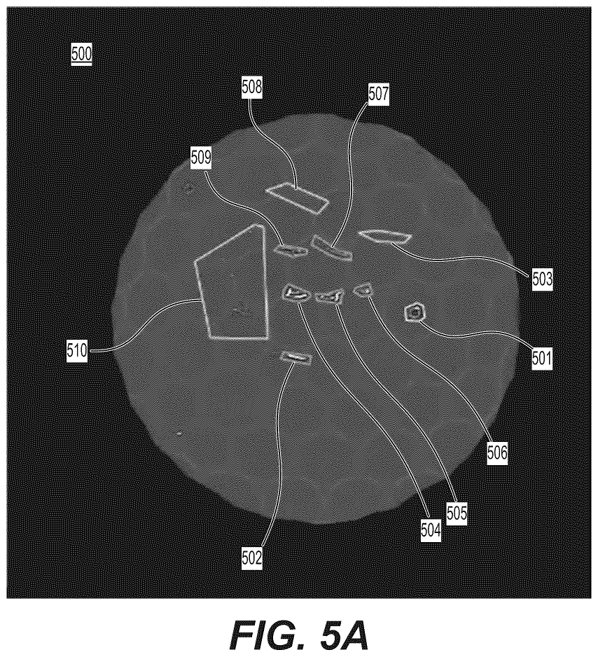

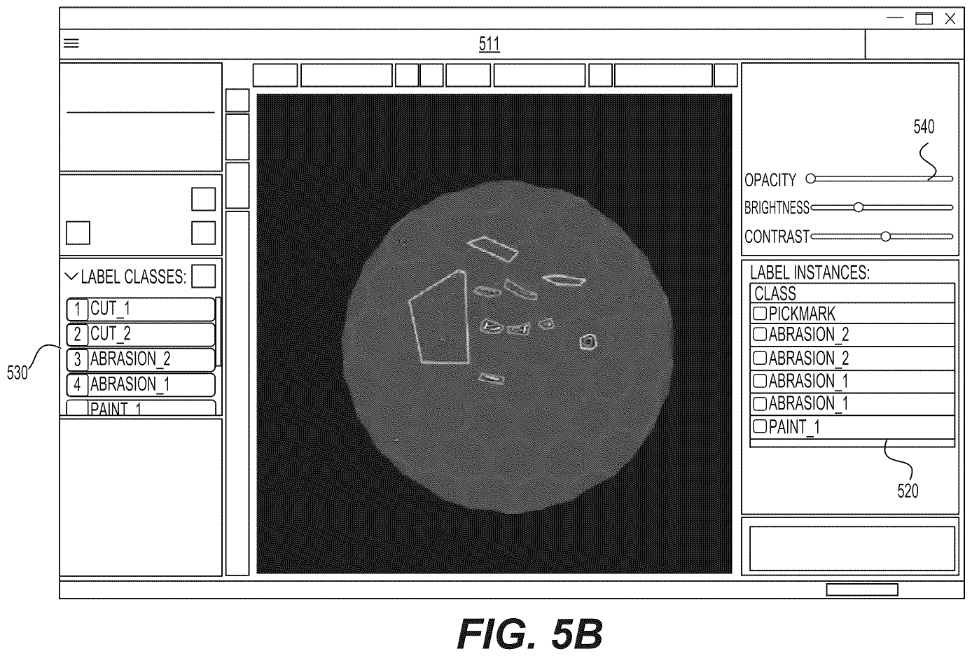

FIGS. 5A and 5B illustrate example GUIs 500, 511 showing annotated images including damage types and extents thereof, according to disclosed embodiments. FIG. 5A illustrates an example received product image (or assessment image) 500 that is further annotated to indicate the location of varying types of damage 501-510 to the surface of the product. FIG. 5B illustrates another exemplary GUI 511 that further includes various additional information and configuration options (e.g., a list of labels 520 such as label instances associated with the indicated damage to the surface of the product, a list of label types 530 available and with options to further configure additional label types, and options enabling the further adjustment of image tone 540, such as opacity, brightness, and contrast). Such options may be displayed, e.g., as shown alongside the annotated displayed image of the product in FIG. 5B. A machine learning model (or another component of a disclosed system) may thus identify the product damage, annotate an image of the product damage, and further output the annotated image and a list of values associated with the identified product damage, wherein the list of values indicates the damage type and an extent of the damage (e.g., low, medium, high, or an integer value). The annotated image may be presented to a user as output, or it may be provided as additional training data to the machine learning model.

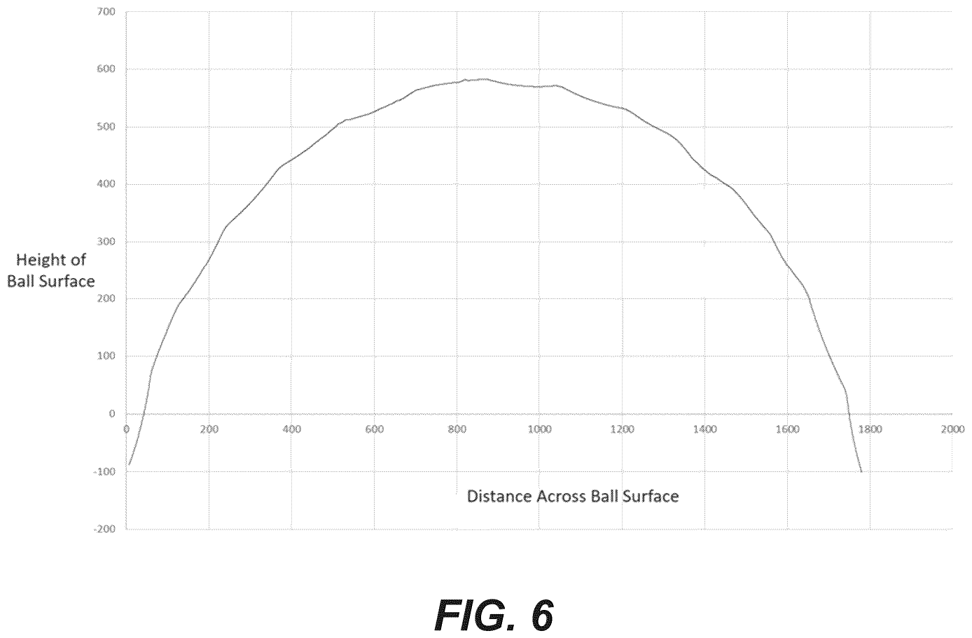

FIGS. 6-9 illustrate various exemplary plots or graphs which may be generated by a machine learning model (e.g., machine learning model 206) or another component of disclosed systems in order to identify surface deviations which amount to product damage (as opposed to expected surface deviations due to, e.g., dimple patterns or curvature). Such exemplary plots or graphs may also be provided as output to a user (e.g., output 214).

FIG. 6 illustrates an exemplary plot or graph that corresponds to a specific portion of a product surface shown in an assessment image, wherein the vertical axis represents the variations in height of the product surface and the horizontal axis represents the distance across the product surface. The plot shown in FIG. 6 illustrates one cross-section (i.e., slice or line) of a product shown in a received image. Only one cross-section is shown in FIG. 6 for illustrative and exemplary purposes, and it will be appreciated based on the present disclosure that a plurality of cross-sections/plots can obtained, generated, analyzed, etc. It will further be understood that the exemplary section or slice can be taken in any direction along the product surface based on the received image, and multiple sections or slices can be obtained from the product image. In one example, a plurality of sections or slices, such as at least 10, 20, 50, 100, 500, 1,000, or 1,680 sections or slices can be obtained for the product. The plot shown in FIG. 6 can be generated via the data or information provided by an imaging device (e.g., imaging device 110) after processing the data and the image via the machine learning model. The plot shown in FIG. 6 may also be generated based on a data file, such as a CSV file, provided or generated via the imaging device or another processor.

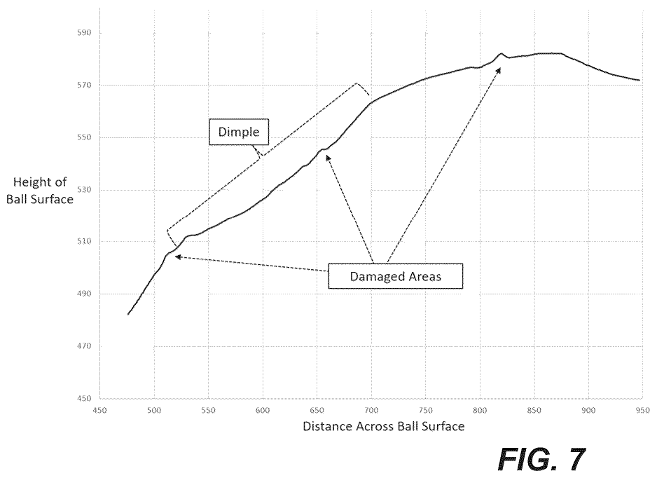

FIG. 7 illustrates an exemplary magnified view of a particular region of a product. Such a magnified view may also form one or more assessment images, as described herein. As shown in FIG. 7, damage to the product surface may be apparent (i.e., the rate of change of the plot is greater) in the areas indicated by annotations in this Figure. A dimple is also apparent in FIG. 7 as shown by the annotation. The system can be configured to execute magnifying techniques or various visualization functions to provide greater detail regarding specific regions on the product surface that are determined based on the area where identifiable damage exists. The surface of an undamaged product will have inherent surface height deviations (e.g., due to dimple patterns), but these changes in height are visibly different from sharper damaged areas, which are randomly positioned on the product surface. These two types of surface deviations can be differentiated, e.g., by a machine learning model when assessing product damage, as described herein.

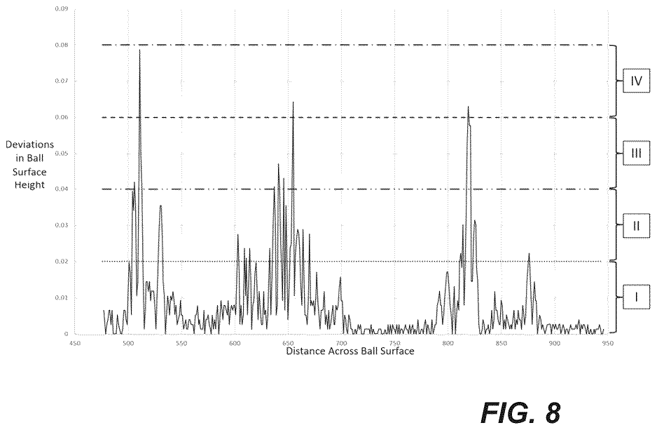

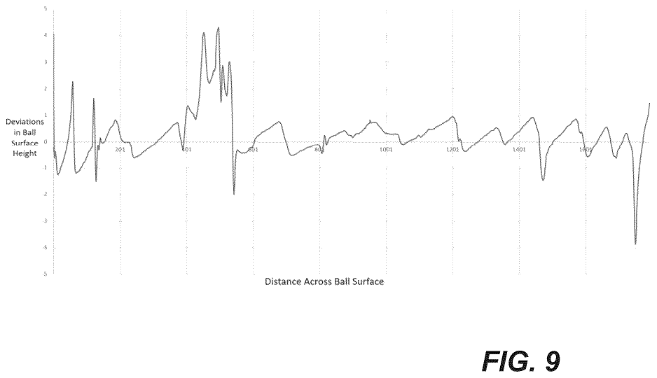

Data or information associated with the dimple pattern (or other height pattern that is original to the ball) of the product surface height may then be used to further emphasize or distinguish between inherent product geometry/features and any disfigurement of the product surface due to damage. For example, the system (e.g., assessment module) can be configured to generate a difference plot, image, or other data file indicating differences between the original dimple pattern and the product damage. FIG. 8 is an exemplary plot showing this difference. Because this plot represents an absolute difference, all the points in the plot showing deviations in the product surface height are greater than zero. As can be observed instead in FIG. 9, the difference signal (e.g., the signal associated with the original dimple surface pattern as compared to the signal associated with the actual ball surface pattern) is at times above and at times below the original. It will be understood that if the absolute value were not used, then the plot would be both positive and negative indicating whether damage was above or below the surface of the ball (as shown in FIG. 9).

In some embodiments, the operations (performed, e.g., by system 204) may also include outputting a grade (e.g., a score or rating) for the product based on the analyzing by the machine learning model (e.g., machine learning model 206). In one aspect, the score or rating associated with the product, if any, can be based on an average score aggregated from the plurality of sections or slices that have been analyzed. In one example, a section or slice can correspond to a 0.001 inch section or slice of the product surface. In one example, the product can be repositioned, and multiple images can be obtained for the product. Accordingly, multiple slices or sections from each orientation or view of the product can be analyzed to generate a single score or rating. It will be understood that more or fewer quantities of sections or slices can be obtained and analyzed according to the present disclosure.

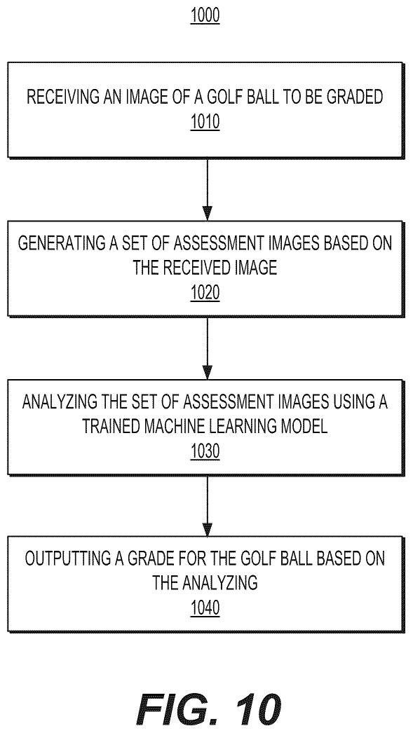

Also disclosed herein are methods for assessing product damage, as discussed below with reference to FIGS. 10-14.

The processes shown in FIGS. 10-14 or any of the constituent steps shown therein may be implemented using operating environment 200, system 204 (e.g., using at least one processor and at least one memory component), or any component thereof. The steps illustrated in FIGS. 10-14 are exemplary and steps may be added, merged, divided, duplicated, repeated (e.g., as part of a machine learning process), modified, performed sequentially, performed in parallel, and/or deleted in some embodiments.

An exemplary method 1000 for assessing product damage, consistent with disclosed embodiments, is illustrated in FIG. 10. As illustrated in FIG. 10, exemplary method 1000 may include a step 1010 of receiving an image of a product to be graded, the image being captured via an imaging device (as described herein). For example, in step 1010 system 204 may receive an image in a format that is usable for a machine-learning operation. For example, the image received in step 1010 may be JPEG. In some embodiments the image may have been pre-processed with filters. In some embodiments the images may be received from a remote image device and in other embodiments the image device may be directly connected to the system 204.

As further illustrated in FIG. 10, method 1000 may include a step 1020 of generating a set of assessment images based on the received image (as described herein). A set of assessment images may refer to one or more assessment images. Example assessment images may include images with increased resolution, images of enlarged portions of the product, annotated images or annotated portions of a product, and other processed or reformatted images that more clearly delineate or indicate product damage. As one non-limiting example, a received image may include a low contrast and resolution image of a product, and generating an assessment image may include increasing both the contrast and the resolution of the received image. As another example, an assessment image may center or otherwise further clarify an area of damage on the product.

As also illustrated in FIG. 10, method 1000 may include a step 1030 of analyzing the set of assessment images using a machine learning model, the machine learning model being trained based on a plurality of product images (e.g., golf ball images) to recognize product damage (e.g., golf ball damage) and generate a grade based on the recognized product damage (as described herein). In some embodiments, the product being analyzed in step 1030 may be a golf ball. In some embodiments, analyzing the set of assessment images may include a first stage of identifying a damage area. For example, a particular side of the product may include a majority of the product damage, and this particular side may be identified as a damage area of the product. In some embodiments, analyzing the set of assessment images may further include modifying the image to focus on the damage area. For example, any of the following may be performed to modify the image to focus on the damage area: rotating, zooming in or out, or otherwise augmenting the product within the received image to show more clearly the damage area and focus less on other areas which do not include product damage. In some embodiments, analyzing the set of assessment images may also include a second stage of identifying a damage type in the damage area. For example, a scuff, abrasion, cut, or coloring may be identified in the damage area. In some embodiments, analyzing the set of assessment images may further include a third stage of determining a level of the identified damage type. For example, a value of low, medium, high, or an integer value may be provided for the level of damage type (e.g., low scuff, medium abrasion, 2-cut, 1-coloring, etc.).

Further, as illustrated in FIG. 10, method 1000 may include a step 1040 of outputting a grade for the product based on the analyzing by the machine learning model (as described herein). For example, in some embodiments system 204 may generate an output file in the form of a .CSV or a .TXT that includes information about the product and the grade determined from the machine learning model. In some embodiments, the grade for the product may be a grade for a product and include information about the damage based on the grading system utilized. For example, a shear resistance score (e.g., a numerical or percentage grading for a product's performance when exposed to various forces) may be provided. For shear resistance scores of golf balls, a numerical value may be assigned based on the ball's performance in shear tests, where the ball is subjected to specific shear forces and then examined for damage. A higher number or percentage may indicate a more shear-resistant (e.g., better performing) product. For example, a product may be rated on a scale from 1 to 100, where 100 may represent maximum shear resistance. Other exemplary gradings may include visual gradings (e.g., qualitative gradings based on surface damage and extent thereof, such as “no visible damage,” “minor scuffing,” “moderate cuts,” or “significant damage”), pass/fail gradings (e.g., a grading of pass or fail based on a predetermined threshold for acceptable damage), force or stress gradings (e.g., an amount of force or stress that a product can withstand before it experiences significant damage, typically expressed in pounds per square inch (PSI) or newtons (N)), wear rate gradings (e.g., a rate at which a product deteriorates under continuous or repeated shear forces), and impact angle and speed-based gradings (e.g., gradings based on how the product withstands shear forces at different angles and speeds, offering a more comprehensive assessment of performance in diverse conditions).

In some embodiments, the method (e.g., method 1000) may also include training the machine learning model. In some embodiments, the training may include obtaining a plurality of training images of products having varying degrees of damage, inputting the plurality of training images to the machine learning model as training data, and training the machine learning model, based on the plurality of training images, to recognize product damage in a received image of a product and grade the product based on the recognized product damage.

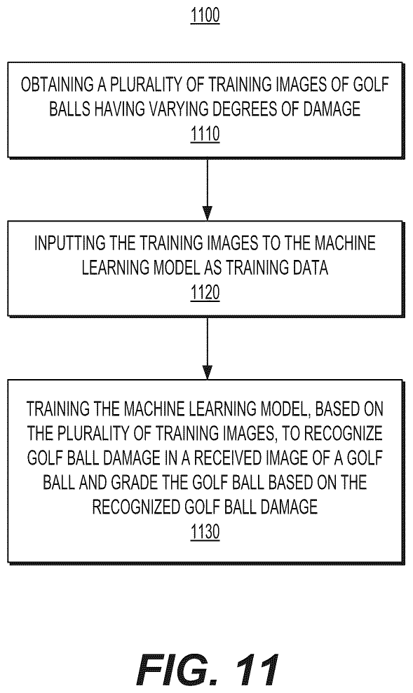

An exemplary method 1100 for training a machine learning model, consistent with disclosed embodiments, is illustrated in FIG. 11. As illustrated in FIG. 11, exemplary method 1100 may include a step 1110 of obtaining a plurality of training images of products having varying degrees of damage (as described herein). Training images may include, e.g., labeled images, unlabeled images, simulated or synthetic images, sequential images, noisy or degraded images, or other images that add to a knowledge base of information. For example, a machine learning model may obtain a series of images of the same golf ball, before and after one or more rounds of shear testing.

As further illustrated in FIG. 11, method 1100 may include a step 1120 of inputting the training images to the machine learning model as training data (as described herein). The training data may be input, e.g., by a systematic process that prepares the data, feeds it into the model, and thereby allows the model to learn from it. For example, inputting the training images may include batching the data into various sizes, utilizing a data loader, or transforming raw data into feature vectors or numerical arrays.

As also illustrated in FIG. 11, method 1100 may include a step 1130 of training the machine learning model, based on the plurality of training images, to recognize product damage in a received image of a product and grade the product based on the recognized product damage (as described herein). Training the machine learning model may include, e.g., forward propagation, backward propagation, loss calculation, optimization, various iterations or epochs, and validating generated data. As an example, a system process of forward propagation and backward propagation, with loss calculation, may be performed to train a machine learning model to grade products based on recognized damage.

In some embodiments of disclosed methods, the step of generating the set of assessment images may include at least one of applying a high-pass filter function to the received image via a computing system, modifying contrast, color, hue, or sharpness of the received image, or reformatting the received image. In some embodiments, the high-pass filter function may be configured to attenuate signals from certain features in products being assessed. For example, when the disclosed system is used for assessing products, the high-pass filter may be associated with a first subset of surface height deviations due to dimples and curvature in the received image of the product and to pass through signals associated with a second subset of surface height deviations due to the product damage. As a result, a predetermined threshold may be set in order to indicate deviations resulting from product damage, and to hide deviations resulting from dimples or curvature of the product. Based on the set threshold, an assessment image may show deviations resulting solely from product damage, while the received image may show deviations resulting from both product damage and dimples or curvature.

In some embodiments of disclosed methods, the machine learning model may be further trained to determine the grade based on an identified type of damage or an extent thereof, and the method may further include outputting the identified type of damage or the extent thereof. In some embodiments, the identified type of damage may include at least one of an abrasion, a dent, a crack, a cut, or coloring. For example, the identified type of damage may include an abrasion, a dent, a crack, a cut, or coloring. An abrasion, as used herein, may refer to physical damage or wear (e.g., a scuff) that occurs on the surface of a product due to, e.g., repeated impact and contact with various surfaces. A dent, as used herein, may refer to a deformation or indentation on the surface of a product. Unlike cuts or abrasions, a dent is typically a shallow depression that alters the original shape of the product surface. A crack, as used herein, may refer to fracture or break in the surface of the product that can penetrate through the outer cover and sometimes even into the core. A cut, as used herein, may refer to a physical defect on the surface of the product that penetrates deeper than an abrasion or scuff. Coloring, as used herein, may refer to discoloration or staining of the product's surface, as well as paint damage. Paint damage may refer to damage to the colored coating of the product, which may occur as a result of, e.g., chipping, fading, peeling, scratching, or discoloration.

In some embodiments of disclosed methods, the step of analyzing the set of assessment images may include a first stage of identifying a damage area, a step of modifying the image to focus on the damage area, a second stage of identifying a damage type in the damage area, and a third stage of determining a level of the identified damage type. For example, a particular side of the product may include a majority of the product damage, and this particular side may be identified as a damage area of the product; then, any of the following may be performed to modify the image to focus on the damage area: rotating, zooming in or out, or otherwise augmenting the product within the received image to show more clearly the damage area and focus less on other areas which do not include product damage. Thereafter, a scuff, abrasion, cut, or coloring may be identified in the damage area. Then, a value of low, medium, high, or an integer value may be provided for the level of damage type (e.g., low scuff, medium abrasion, 2-cut, 1-coloring, etc.).

In some embodiments of disclosed methods, the imaging device may include an adjustable aperture lens or a color sensor (or a calibrated measurement tool (e.g., a color calibrator or photogrammetric calibrator)). Adjusting the aperture opening size may control the amount of light that reaches the camera (or a sensor thereof) and influences other aspects of a captured image, such as the depth of field and the sharpness. Hence, an adjustable aperture lens may improve the imaging device by enabling control over light exposure, depth of field, image sharpness, and motion blur. Such flexibility may improve the quality, versatility, and functionality of the imaging device. The color sensor may include photodetectors, color filters, analog to digital converters, light sources, and/or microcontrollers. A color sensor may improve the imaging device by, e.g., enhancing its ability to accurately capture, reproduce, and process colors and producing more precise and true-to-life color representation in images that are captured by the imaging device. The imaging device may also include an onboard graphics processing unit (GPU, e.g., a graphics processor that is built directly into the motherboard or CPU of a device rather than being a separate, dedicated graphics card) or an AI chip (e.g., a specialized hardware component engineered to perform complex computations for AI workloads, such as deep learning, neural networks, and inference processing, which often require large amounts of parallel computing power). In some embodiments, the set of assessment images may include images in different spectrums including at least two colors. Viewing the received image in a particular spectrum may be beneficial to, e.g., highlight a particular type of damage or a particular attribute of the damage that may be more visible or identifiable when the image is shown in a specific spectrum or color.

In some embodiments of disclosed methods, the method may further include annotating the received image or at least one of the set of assessment images to indicate damage to a corresponding product, and inputting the annotated image to the machine learning model as additional training data. For example, one or more image annotation tools may be utilized to draw bounding boxes, polygons, segmentation masks, or other informative symbols to highlight damage areas of the product, and these annotations may be exported as training data to be fed to a machine learning model using one or more frameworks or object detection models.

In some embodiments of disclosed methods, the operations may further include inputting refining data to the machine learning model, and further training the machine learning model using the refining data, wherein the refining data indicates an association between received training data and at least one of a type of product material or a type of dimple pattern. For example, the refining data may include information associated with a particular product's dimple pattern, which would assist in contrasting between surface deviations resulting from the dimple pattern as opposed to surface deviations resulting from damage to the product.

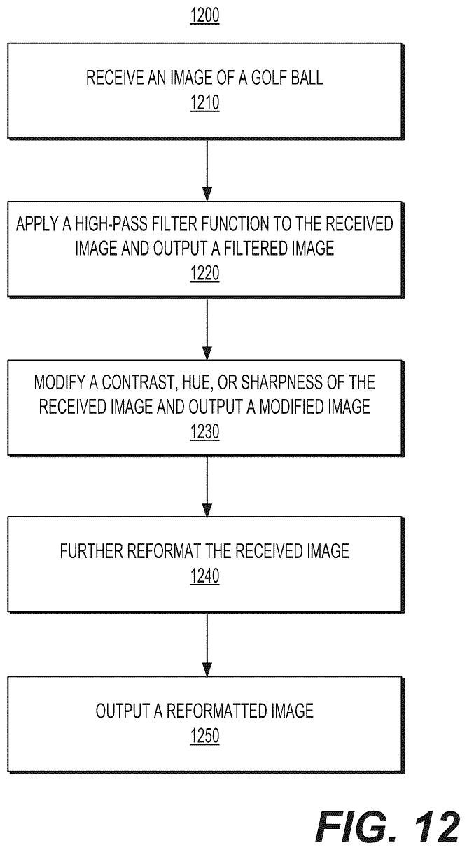

An exemplary method 1200 for assessing product damage, consistent with disclosed embodiments, is illustrated in FIG. 12. As illustrated in FIG. 12, exemplary method 1200 may include a step 1210 of receiving an image of a product (as described herein). For example, in step 1210, system 204 may receive an image in a format that is usable for a machine-learning operation. For example, the image received in step 1210 may be JPEG. In some embodiments, the image may have been pre-processed with filters. In some embodiments the images may be received from a remote image device and in other embodiments the image device may be directly connected to the system (e.g., system 204).

As further illustrated in FIG. 12, method 1200 may include a step 1220 of applying a high-pass filter function to the receive image and outputting a filtered image (as described herein). For example, a received image may include various specks and marks on the product, and a high-pass filter function may be applied to the received image to remove certain specks and marks that are below a predetermined threshold value. As a result of applying the filter function, more critical damage may be highlighted while less relevant damage may be hidden or removed from view.

As also illustrated in FIG. 12, method 1200 may include a step 1230 of modifying a contrast, hue, or sharpness of the receive image and outputting a modified image (as described herein). For example, a received image may have high contrast or sharpness thereby rendering the image less optimal for indicating product damage, and the received image may be modified to have a lower contrast or sharpness to enable easier identification of the product damage without needing to capture another image of the product.

Further, as illustrated in FIG. 12, method 1200 may include a step 1240 of further reformatting the received image (as described herein). Further reformatting may include, e.g., rotating, shifting, scaling, flipping, cropping, zooming, altering shape, color jittering (e.g., applying random variations to the colors of an image), normalizing pixels, standardizing pixels, performing color conversion, masking out (e.g., selectively excluding or modifying specific parts of an image), or otherwise augmenting or processing an image or a portion thereof. For example, the received image may further be reformatted to zoom in on and center the primary product damage (e.g., to clarify the damage).

Even further, as illustrated in FIG. 12, method 1200 may include a step 1250 of outputting one or more reformatted images (as described herein). Outputting may refer to providing the one or more reformatted images to a system, processor, user, or machine learning model. For example, various reformatted images may be provided to a machine learning model trained and configured to generate scores based on the reformatted images.

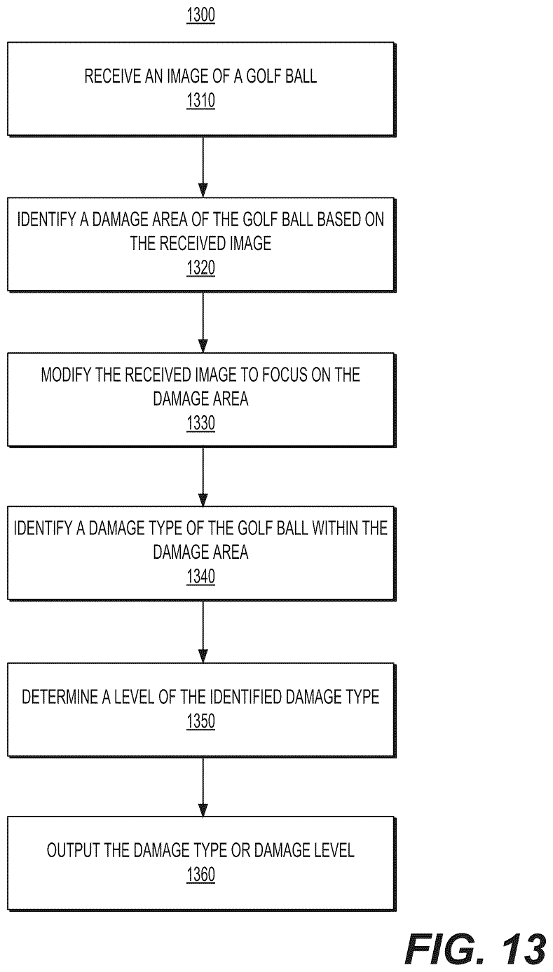

An exemplary method 1300 for assessing product damage, consistent with disclosed embodiments, is illustrated in FIG. 13. As illustrated in FIG. 13, exemplary method 1300 may include a step 1310 of receiving an image of a product (as described herein). For example, in step 1210, system 204 may receive an image (e.g., an image of a golf ball) in a format that is usable for a machine-learning operation. For example, the image received in step 1210 may be JPEG. In some embodiments, the image may have been pre-processed with filters. In some embodiments the images may be received from a remote image device and in other embodiments the image device may be directly connected to the system (e.g., system 204).

As further illustrated in FIG. 13, method 1300 may include a step 1320 of identifying a damage area of the product based on the received image (as described herein). For example, a particular side of the product may include a majority of the product damage, and this particular side may be identified as a damage area of the product.

As also illustrated in FIG. 13, method 1300 may include a step 1330 of modifying the received image to focus on the damage area (as described herein). For example, any of the following may be performed to modify the image to focus on the damage area: rotating, zooming in or out, or otherwise augmenting the product within the received image to show more clearly the damage area and focus less on other areas which do not include product damage.

Further, as illustrated in FIG. 13, method 1300 may include a step 1340 of identifying a damage type of the product within the damage area (as described herein). For example, a scuff, abrasion, cut, or coloring may be identified in the damage area.

Even further, as illustrated in FIG. 13, method 1300 may include a step 1350 of determining a level of the identified damage type (as described herein). For example, a value of low, medium, high, or an integer value may be provided for the level of damage type (e.g., low scuff, medium abrasion, 2-cut, 1-coloring, etc.).

As further illustrated in FIG. 13, method 1300 may include a step 1360 of outputting the damage type or damage level (as described herein). For example, one or more of the above example values may be provided to a user or processor (e.g., for further processing or analysis).

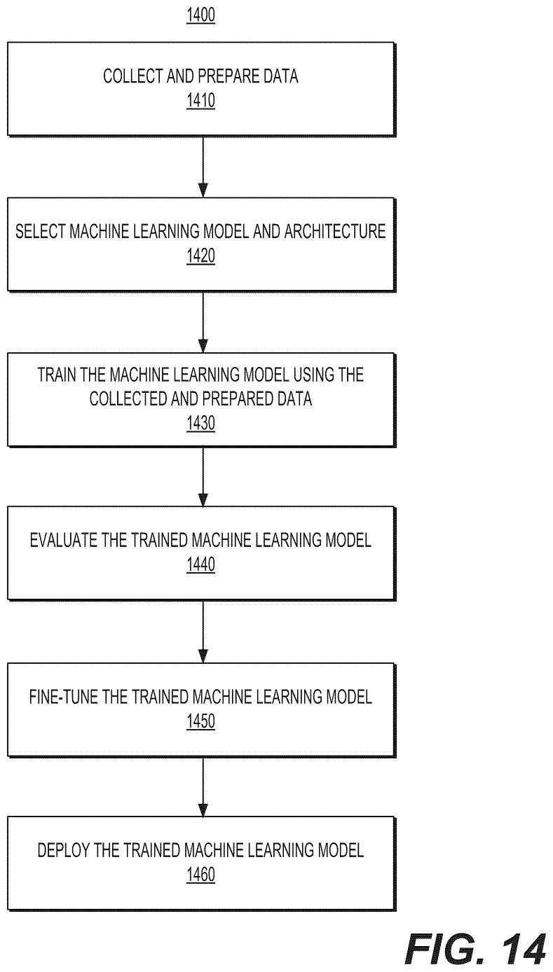

An exemplary method 1400 for training a machine learning model, consistent with disclosed embodiments, is illustrated in FIG. 14. In some embodiments, the machine learning model may be trained and configured to assess product damage, as described herein. As illustrated in FIG. 14, exemplary method 1400 may include a step 1410 of collecting and preparing data. Collecting and preparing data may include, e.g., acquiring, accessing, or generating training data, cleaning and pre-processing data (e.g., handling missing values, normalizing data, or encoding categorical variables), and splitting data into training data sets and validation data sets. As further illustrated in FIG. 14, method 1400 may also include a step 1420 of selecting a machine learning model and architecture. Step 1420 may include, e.g., selecting an appropriate machine learning algorithm or model type, defining the model architecture (e.g., number of layers, neurons, activation functions), and setting hyperparameters (e.g., learning rate, regularization). As also illustrated in FIG. 14, method 1400 may further include a step 1430 of training the machine learning model using the collected and prepared data. For example, step 1430 may include initializing the machine learning model with random weights and biases, iterating over the training data (e.g., performing a forward pass, calculating the loss/error between predicted output and true output, and performing a backward pass), and/or repeating iteration until convergence or a predefined stopping criterion is met. Further, as shown in FIG. 14, method 1400 may include a step 1440 of evaluating the trained machine learning model. Step 1440 may include, e.g., assessing the machine learning model's performance based on a validation data set (e.g., computing evaluation metrics such as accuracy, precision, recall, and/or F1-score, and/or analyzing results and adjusting model architecture). As also shown in FIG. 14, method 1400 may include a step 1450 of fine-tuning the trained machine learning model. As shown in FIG. 14, method 1400 may also include a step 1460 of deploying the trained machine learning model. For example, step 1460 may include deploying the machine learning model to a production environment, monitoring the machine learning model's performance, updating the machine learning model as needed, and/or using the machine learning model to generate output based on a given input.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer-readable medium(s) may be utilized. The computer-readable medium may be a non-transitory computer-readable storage medium. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, RF, IR, etc., or any suitable combination of the foregoing.

Computer program code for carrying out operations, for example, embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

This disclosure may be described in the general context of customized hardware capable of executing customized preloaded instructions such as, e.g., computer-executable instructions for performing program modules. Program modules may include one or more of routines, programs, objects, variables, commands, scripts, functions, applications, components, data structures, and so forth, which may perform particular tasks or implement particular abstract data types. The disclosed embodiments may also be practiced in distributed computing environments where tasks are performed by remote processing devices that are linked through a communications network. In a distributed computing environment, program modules may be located in local and/or remote computer storage media including memory storage devices.

The embodiments discussed herein involve or relate to artificial intelligence (AI). AI may involve perceiving, synthesizing, inferring, predicting and/or generating information using computerized tools and techniques (e.g., machine learning). For example, AI systems may use a combination of hardware and software as a foundation for rapidly performing complex operation to perceive, synthesize, infer, predict, and/or generate information. AI systems may use one or more models, which may have a particular configuration (e.g., model parameters and relationships between those parameters, as discussed below). While a model may have an initial configuration, this configuration can change over time as the model learns from input data (e.g., training input data), which allows the model improve its abilities. For example, a dataset may be input to a model, which may produce an output based on the dataset and the configuration of the model itself. Then, based on additional information (e.g., an additional input dataset, validation data, reference data, feedback data), the model may deduce and automatically electronically implement a change to its configuration that will lead to an improved output.

Powerful combinations of model parameters and sufficiently large datasets, together with high-processing-capability hardware, can produce sophisticated models. These models enable AI systems to interpret incredible amounts of information according to the model being used, which would otherwise be impractical, if not impossible, for the human mind to accomplish. The results, including the results of the embodiments discussed herein, are astounding across a variety of applications. For example, an AI system can be configured to autonomously navigate vehicles, automatically recognize objects, instantly generate natural language, understand human speech, and generate artistic images. The results of the embodiments discussed herein further show that AI systems can be configured to assess product damage with more accuracy, at a greater speed, and without implementing as many human resources, if any. Furthermore, the AI systems described herein improve the processing speed of the processor(s) and computing device disclosed herein. For example, by generating more accurate and objective scores for each product image using an AI system (e.g., a machine learning model), the processor(s) or computing device(s) is improved by receiving such scores from the machine learning model and taking further steps (e.g., performing further analysis) using the received scores (as compared, e.g., to the processor(s) or computing device(s) receiving subjective and skewed scores from human individuals or other subjective methods instead).

The flowchart and block diagrams in the figures illustrate examples of the architecture, functionality, and operation of possible implementations of systems, methods, and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

It will be apparent to those skilled in the art that various modifications and variations can be made to the disclosed embodiments of the launch monitor. Other embodiments will be apparent to those skilled in the art from consideration of the specification and practice of the disclosed launch monitor. Therefore, it will be understood that the appended claims are intended to cover all such modifications and embodiments, which would come within the spirit and scope of the present disclosure.

What is claimed is:

1. A system for assessing golf ball damage, the system comprising:
an imaging device;
at least one memory storing instructions; and
at least one processor configured to execute the instructions to perform operations for assessing golf ball damage, the operations comprising:
receiving an image of a golf ball to be graded, the image being captured via the imaging device;
generating a set of assessment images based on the received image;
analyzing the set of assessment images using a machine learning model, the machine learning model being trained based on a plurality of golf ball images to recognize golf ball damage and generate a grade based on the recognized golf ball damage; and
outputting a grade for the golf ball based on the analyzing by the machine learning model.

2. The system of claim 1, wherein the operations further comprise:
training the machine learning model, wherein the training comprises:
obtaining a plurality of training images of golf balls having varying degrees of damage;
inputting the plurality of training images to the machine learning model as training data; and
training the machine learning model, based on the plurality of training images, to recognize golf ball damage in a received image of a golf ball and grade the golf ball based on the recognized golf ball damage.

3. The system of claim 2, wherein generating the set of assessment images comprises at least one of:
applying a high-pass filter function to the received image via a computing system;
modifying contrast, color, hue, or sharpness of the received image; or
reformatting the received image.

4. The system of claim 3, wherein the high-pass filter function is configured to:
attenuate signals associated with a first subset of surface height deviations due to dimples and curvature in the received image of the golf ball; and
pass through signals associated with a second subset of surface height deviations due to the golf ball damage.

5. The system of claim 1, wherein the machine learning model is further trained to determine the grade based on an identified type of damage or an extent thereof, and the operations further comprise outputting the identified type of damage or the extent thereof.

6. The system of claim 6, wherein the identified type of damage includes at least one of an abrasion, a dent, a crack, a cut, or coloring.

7. The system of claim 11, wherein analyzing the set of assessment images comprises:
a first stage of identifying a damage area;
modifying the image to focus on the damage area;
a second stage of identifying a damage type in the damage area; and
a third stage of determining a level of the identified damage type.

8. The system of claim 1, wherein:
the imaging device comprises an adjustable aperture lens or a color sensor; or
the set of assessment images comprises images in different spectrums including at least two colors.

9. The system of claim 1, the operations further comprising:
annotating the received image or at least one of the set of assessment images to indicate damage to a corresponding golf ball; and
inputting the annotated image to the machine learning model as additional training data.

10. The system of claim 1, the operations further comprising:
inputting refining data to the machine learning model; and
further training the machine learning model using the refining data, wherein the refining data indicates an association between received training data and at least one of a type of material or a type of dimple pattern.

11. A method for assessing golf ball damage, the method comprising:
receiving an image of a golf ball to be graded, the image being captured via an imaging device;
generating a set of assessment images based on the received image;
analyzing the set of assessment images using a machine learning model, the machine learning model being trained based on a plurality of golf ball images to recognize golf ball damage and generate a grade based on the recognized golf ball damage; and
outputting a grade for the golf ball based on the analyzing by the machine learning model.

12. The method of claim 11, wherein generating the set of assessment images comprises at least one of:
applying a high-pass filter function to the received image via a computing system;
modifying contrast, color, hue, or sharpness of the received image; or
reformatting the received image.

13. The method of claim 12, wherein the high-pass filter function is configured to:
attenuate signals associated with a first subset of surface height deviations due to dimples and curvature in the received image of the golf ball; and
pass through signals associated with a second subset of surface height deviations due to the golf ball damage.

14. The method of claim 11, wherein the machine learning model is further trained to determine the grade based on an identified type of damage or an extent thereof, the method further comprising outputting the identified type of damage or the extent thereof.

15. The method of claim 14, wherein the identified type of damage includes at least one of an abrasion, a dent, a crack, a cut, or coloring.

16. The method of claim 11, wherein analyzing the set of assessment images comprises:
a first stage of identifying a damage area;
modifying the image to focus on the damage area;
a second stage of identifying a damage type in the damage area; and
a third stage of determining a level of the identified damage type.

17. The method of claim 11, wherein:
the imaging device comprises an adjustable aperture lens or a color sensor; or
the set of assessment images comprises images in different spectrums including at least two colors.

18. The method of claim 11, further comprising:
annotating the received image to indicate damage to a corresponding golf ball to generate an annotated image; and
inputting the annotated image to the machine learning model as additional training data.

19. The method of claim 11, further comprising:
inputting refining data to the machine learning model; and
further training the machine learning model using the refining data, wherein the refining data indicates an association between received training data and at least one of a type of material or a type of dimple pattern.

20. A networked device comprising one or more processors to perform operations for assessing golf ball damage, the operations comprising:
obtaining a plurality of first images of first golf balls having varying degrees of damage;
inputting the plurality of first images to a machine learning model as training data;
training the machine learning model to recognize and grade a severity of damage to a second golf ball based on a received second image of the second golf ball;
receiving the second image of the second golf ball to be graded;
analyzing the second image using the trained machine learning model; and
outputting a grade for the second golf ball based on the analyzing of the second image by the machine learning model.
